(19) United States
(12) Patent Application Publication
(10) Pub. No.: US 2024/0124693 A1
(43) Pub. Date: Apr. 18, 2024

(54) PROPYLENE POLYMER COMPOSITION

(71) Applicant: BASELL POLIOLEFINE ITALIA S.R.L., Milano (IT)

(72) Inventors: Paola Massari, Ferrara (IT); Andrea Felisati, Ferrara (IT); Claudio Cavalieri, Ferrara (IT); Monica Galvan, Ferrara (IT); Michele Grazzi, Ferrara (IT)

(73) Assignee: Basell Poliolefine Italia S.r.l., Milano (IT)

(21) Appl. No.: 18/265,343

(22) PCT Filed: Nov. 25, 2021
(86) PCT No.: PCT/EP2021/082938

§ 371 Date: Jun. 5, 2023

(30) Foreign Application Priority Data
Dec. 9, 2020 (EP) 20212689.2

(51) Int. Cl. C08L 23/10; C08J 5/18

(52) U.S. Cl. CPC C08L 23/10; C08J 5/18; C08J 2323/16; C08J 2423/18; C08L 2203/162

(57) ABSTRACT

A polymer composition made from or containing:

A) from 70 wt % to 95 wt % of a propylene polymer composition made from or containing

A1) from 19 wt % to 50 wt % of a propylene ethylene copolymer;

A2) from 50 wt % to 81 wt % of a propylene ethylene 1-butene terpolymer;

wherein the sum of the amount of component A1) and A2) being 100 and

the propylene polymer composition A) having a xylene soluble fraction at 25° C. between 2 wt % and 15 wt %; and

B) from 5.0 wt % to 30.0 wt % of a copolymer of 1-butene and ethylene containing from 3.0 wt % to 4.2 wt % of ethylene derived units.

### FIELD OF THE INVENTION

In general, the present disclosure relates to the field of chemistry. More specifically, the present disclosure relates to polymer chemistry. In particular, the present disclosure relates to propylene compositions and films made therefrom.

### BACKGROUND OF THE INVENTION

In some instances, polypropylene compositions are used for making films in the packaging field and in the non-packaging field. In some instances, polypropylene compositions are used in food and non-food packaging applications.

In some instances, the packaging is used for hygienic items, textile articles, magazines, mailing films, secondary collation packaging, shrink packaging films and sleeves, stretch packaging films and sleeves, form-fill-seal packaging films for portioning various types of articles, and vacuum formed blisters. In some instances, the articles are bags, pouches, or sachets.

In some instances, form-fill-seal applications include packaging of peat and turf, chemicals, plastic resins, mineral products, food products, and small size solid articles.

As used herein, the term “flexible plastic packaging” includes plastic films for packaging.

In some instances, non-packaging items include synthetic clothing articles, medical and surgical films, films which are formed into flexible conveying pipes, membranes for isolation and protection in soil, building and construction applications, and films which are laminated with non-woven membranes.

### SUMMARY OF INVENTION

In a general embodiment, the present disclosure provides a polymer composition made from or containing:
A) from 70 wt % to 95 wt % of a propylene polymer composition made from or containing
A1) from 19 wt % to 50 wt % of a propylene ethylene copolymer having an ethylene derived units content ranging from 1.5 wt % to 6.0 wt %, based upon the total weight of the propylene ethylene copolymer; and
A2) from 50 wt % to 81 wt % of a propylene ethylene 1-butene terpolymer having an ethylene derived units content ranging from 1.5 wt % to 6.0 wt % and 1-butene derived units content ranging from 4.8 wt % to 12.4 wt %, based upon the total weight of the terpolymer;
wherein the propylene polymer composition A) having a xylene soluble fraction at 25° C. between 2 wt % and 15 wt %, based upon the total weight of the propylene polymer composition A), and
the sum of the amounts of Al) and A2) being 100 wt %; and
B) from 5.0 wt % to 30.0 wt % of a copolymer of 1-butene and ethylene containing from 3.0 wt % to 4.2 wt % of ethylene derived units, based upon the total weight of the 1-butene ethylene copolymer, and having
a Melt Flow Rate: measured according to ISO 1133-1-(190° C., 2.16 Kg) ranging from 1.0 to 5.5 g/10 min;
a flexural modulus measured according to ISO 178 ranging from 80 MPa to 250 MPa; and
a melting temperature measured according to ISO 11357-3 ranging from 83° C. and 108° C., form I,
wherein the sum of the amounts of A) and B) being 100 wt %.

### DETAILED DESCRIPTION OF THE INVENTION

In some embodiments, the present disclosure provides a polymer composition made from or containing:
A) from 70.0 wt % to 95.0 wt %, alternatively from 72.0 wt % to 93.0 wt %; alternatively from 74.0 wt % to 87.0 wt %, of a propylene polymer composition (A) made from or containing
A1) from 19 wt % to 50 wt %, alternatively from 25 wt % to 42 wt %, alternatively from 31 wt % to 38 wt %, of a propylene ethylene copolymer having an ethylene derived units content ranging from 1.5 wt % to 6.0 wt %, alternatively from 2.6 wt % to 5.2 wt %, alternatively from 2.8 wt % to 4.3 wt %, based upon the total weight of the propylene ethylene copolymer; and
A2) from 50 wt % to 81 wt %, alternatively from 58 wt % to 75 wt %, alternatively from 62 wt % to 69 wt %, of a propylene ethylene 1-butene terpolymer having an ethylene derived units content ranging from 1.5 wt % to 6.0 wt %, alternatively from 1.9 wt % to 4.8 wt %, alternatively from 2.1 wt % to 3.7 wt %, and 1-butene derived units content ranging from 4.8 wt % to 12.4 wt %, alternatively from 5.1 wt % to 10.5 wt %, alternatively from 6.8 wt % to 10.0 wt %, based upon the total weight of the terpolymer;
wherein the sum of the amount of component A1) and A2) being 100 wt % and
the propylene polymer composition A) having a xylene soluble fraction at 25° C. between 2.0 and 15.0 wt %, alternatively between 5.0 and 13.0 wt %, alternatively between 7.0 and 11.5 wt %, based upon the total weight of the propylene polymer composition A); and
B) from 5.0 wt % to 30.0 wt %; alternatively from 7.0 wt % to 28.0 wt %; alternatively from 13.0 wt % to 26 wt %, of a copolymer of 1-butene and ethylene containing from 3.0 wt % to 4.2 wt %, alternatively from 3.2 wt % to 4.0 wt %; alternatively from 3.3 wt % to 3.9 wt %, of ethylene derived units, based upon the total weight of the 1-butene ethylene copolymer, and having:
a Melt Flow Rate: measured according to ISO 1133-1-(190° C., 2.16 Kg) ranging from 1.0 to 5.5 g/10 min, alternatively from 2.1 to 4.8 g/10 min; alternatively from 2.4 to 4.1 g/10 min;
a flexural modulus measured according to ISO 178 ranging from 50 MPa to 250 MPa; alternatively ranging from 80 MPa to 210 MPa; alternatively ranging from 92 MPa, to 174 MPa; and
a melting temperature measured according to ISO 11357-3 ranging from 83° C. and 108° C., alternatively ranging from 84° C. and 103° C.; alternatively ranging from 88° C. and 100° C., form I;
wherein the sum of the amounts of A) and B) being 100 wt %.

As used herein, the term “copolymer” refers to polymers containing two comonomers such as propylene and ethylene or 1-butene and ethylene. As used herein, the term “propylene ethylene 1-butene terpolymer” refers to a polymer made from or containing propylene, ethylene, and 1-butene comonomers.

In some embodiments, the propylene polymer composition (A) is prepared by a process including the step of polymerizing propylene with ethylene and propylene with ethylene and 1-butene, in the presence of a catalyst made from or containing a product of the reaction between:
(i) a solid catalyst component made from or containing Ti, Mg, Cl, and an electron donor compound (internal donor);
(ii) an alkylaluminum compound; and
(iii) an electron-donor compound (external donor).

In some embodiments, the particles of solid component have substantially spherical morphology and an average diameter ranging between 5 μm and 150 μm alternatively from 20 μm to 100 μm alternatively from 30 μm to 90 μm. As used herein, the term “substantially spherical morphology” refers to particles having the ratio between the greater axis and the smaller axis equal to or lower than 1.5, alternatively lower than 1.3.

In some embodiments, the amount of Mg ranges from 8 wt % to 30 wt %, alternatively from 10 wt % to 25 wt %, based upon the total weight of the solid catalyst component.

In some embodiments, the amount of Ti ranges from 0.5 wt % to 5 wt %, alternatively from 0.7 wt % to 3 wt %, based upon the total weight of the solid catalyst component. In some embodiments, the internal electron donor compounds are 1,3-diethers of formula:

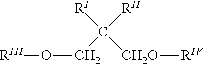

wherein R^{I} and R^{II} are the same or different and are C₁-C₁₈ alkyl, C₃-C₁₈ cycloalkyl, or C7-C18 aryl radicals; R^{III} and R^{IV} are the same or different and are C₁-C₄ alkyl radicals; or are the 1,3-diethers wherein the carbon atom in position 2 belongs to a cyclic or polycyclic structure made up of 5, 6, or 7 carbon atoms, or of 5-n or 6-n′ carbon atoms, and respectively n nitrogen atoms and n′ heteroatoms selected from the group consisting of N, O, S and Si, where n is 1 or 2 and n′ is 1, 2, or 3, the structure containing two or three unsaturations (cyclopolyenic structure), and optionally being condensed with other cyclic structures, or substituted with one or more substituents selected from the group consisting of linear or branched alkyl radicals; cycloalkyl, aryl, aralkyl, alkaryl radicals and halogens, or being condensed with other cyclic structures and substituted with one or more of the above mentioned substituents; one or more of the above mentioned alkyl, cycloalkyl, aryl, aralkyl, or alkaryl radicals and the condensed cyclic structures optionally containing one or more heteroatom(s) as substitutes for carbon or hydrogen atoms, or both. In some embodiments, the substituents are bonded to the condensed cyclic structures.

In some embodiments, the ethers are selected from the ethers described in European Patent Application Nos. 361493 and 728769.

In some embodiments, the diethers are selected from the group consisting of 2-methyl-2-isopropyl-1,3-dimethoxypropane, 2,2-diisobutyl-1,3-dimethoxypropane, 2-isopropyl-2-cyclopentyl-1,3-dimethoxypropane, 2-isopropyl-2-isoamyl-1,3-dimethoxypropane, and 9,9-bis (methoxymethyl) fluorene.

In some embodiments, the Mg/Ti molar ratio is equal to, or higher than, 13, alternatively in the range 14-40, alternatively from 15 to 40. In some embodiments, the Mg/donor molar ratio is higher than 16, alternatively higher than 17, alternatively ranging from 18 to 50.

In some embodiments, the solid catalyst component is prepared by reacting a titanium compound of formula Ti(OR)_{q-y}X_{y}, where q is the valence of titanium and y is a number between 1 and q, with a magnesium chloride deriving from an adduct of formula MgCl₂·pROH, where p is a number between 0.1 and 6, alternatively from 2 to 3.5, and R is a hydrocarbon radical having 1-18 carbon atoms. In some embodiments, the titanium compound is TiCl₄. In some embodiments, the adduct is prepared in spherical form by mixing alcohol and magnesium chloride, operating under stirring conditions at the melting temperature of the adduct (100-130° C.). Then, the adduct is mixed with an inert hydrocarbon immiscible with the adduct thereby creating an emulsion which is quickly quenched and causing the solidification of the adduct in form of spherical particles. In some embodiments, the procedure for the preparation of the spherical adducts is as disclosed in U.S. Pat. Nos. 4,399,054 and 4,469,648. In some embodiments, the resulting adduct is directly reacted with a Ti compound or subjected to thermally-controlled dealcoholation (80-130° C.), thereby obtaining an adduct wherein the number of moles of alcohol is lower than 3, alternatively between 0.1 and 2.5. In some embodiments, the reaction with the Ti compound is carried out by suspending the adduct (dealcoholated or as such) in cold TiCl₄; the mixture is heated up to 80-130° C. and kept at this temperature for 0.5-2 hours. In some embodiments, the temperature of the cold TiCl₄ is 0° C.

In some embodiments, the treatment with TiCl₄ is carried out one or more times. In some embodiments, the internal electron donor compound is added during the treatment with TiCl₄.

In some embodiments, the alkylaluminum compound (ii) is selected from the group consisting of trialkyl aluminum compounds, alkylaluminum halides, alkylaluminum hydrides, and alkylaluminum sesquichlorides. In some embodiments, alkylaluminum compound (ii) is a trialkyl aluminum compound selected from the group consisting of triethylaluminum, triisobutylaluminum, tri-n-butylaluminum, tri-n-hexylaluminum, and tri-n-octylaluminum. In some embodiments, the alkylaluminum compound (ii) is an alkylaluminum sesquichlorides selected from the group consisting of AlEt₂Cl and Al₂Et₃Cl₃. In some embodiments, the alkylaluminum compound (ii) is a mixture including trialkylaluminums. In some embodiments, the Al/Ti ratio is higher than 1, alternatively between 50 and 2000.

In some embodiments, the external electron-donor compounds are selected from the group consisting of silicon compounds, ethers, esters, amines, heterocyclic compounds, and ketones. In some embodiments, the heterocyclic compound is 2,2,6,6-tetramethylpiperidine.

In some embodiments, the external donor compounds are silicon compounds of formula (R₆)ₐ(R₇)_{b}Si(OR₈)_{c}, where a and b are integers from 0 to 2, c is an integer from 1 to 4, and the sum (a+b+c) is 4; R₆, R₇, and R₈ are alkyl, cycloalkyl or aryl radicals with 1-18 carbon atoms optionally containing heteroatoms. In some embodiments, a is 1, b is 1, c is 2, at least one of R₆ and R₇ is selected from branched alkyl, cycloalkyl or aryl groups with 3-10 carbon atoms optionally containing heteroatoms, and R₈ is a C₁-C₁₀ alkyl group. In some embodiments, R₈ is methyl. In some embodiments, the silicon compounds are selected from the group consisting of methylcyclohexyldimethoxysilane (C donor), diphenyldimethoxysilane, methyl-t-butyldimethoxysilane, dicyclopentyldimethoxysilane (D donor), diisopropyldimethoxysilane, (2-ethylpiperidinyl)t-butyldimethoxysilane, (2-ethylpiperidinyl)thexyldimethoxysilane, (3,3,3-trifluoro-n-propyl)-(2-ethylpiperidinyl)-dimethoxysilane, and methyl(3,3,3-trifluoro-n-propyl)dimethoxysilane. In some embodiments, a is 0, c is 3, R₇ is a branched alkyl or cycloalkyl group, optionally containing heteroatoms, and R₈ is methyl. In some embodiments, the silicon compounds are selected from the group consisting of cyclohexyltrimethoxysilane, t-butyltrimethoxysilane, and thexyltrimethoxysilane.

In some embodiments, the electron donor compound (iii) is used in an amount such that the molar ratio between the alkylaluminum compound (ii) and the electron donor compound (iii) is from 0.1 to 500, alternatively from 1 to 300, alternatively from 3 to 100.

In some embodiments, the polymerization process is carried out in a slurry polymerization, using as diluent an inert hydrocarbon solvent, or a bulk polymerization, using the liquid monomer as a reaction medium. In some embodiments, the liquid monomer is propylene. In some embodiments, the polymerization process is carried out in gas-phase, operating in one or more fluidized or mechanically agitated bed reactors.

In some embodiments, the polymerization is carried out at temperature of from 20 to 120° C., alternatively from 40 to 80° C. In some embodiments, the polymerization is carried out in gas-phase with an operating pressure between 0.5 and 5 MPa, alternatively between 1 and 4 MPa. In some embodiments, the polymerization is carried out in bulk polymerization with an operating pressure between 1 and 8 MPa, alternatively between 1.5 and 5 MPa. In some embodiments, hydrogen is used as a molecular weight regulator.

In some embodiments, the propylene polymer composition (A) is commercially available under the tradename Adsyl 5C 90 F s from LyondellBasell.

In some embodiments, the 1-butene ethylene copolymer B) is commercially available under the tradename Koattro DP 8310M from LyondellBasell. In some embodiments, the 1-butene ethylene copolymer B) is prepared using Ziegler Natta catalysts.

In some embodiments, the polymer composition is prepared by mechanically blending component A) and component B).

In some embodiments, the polymer composition is used for the preparation of films, alternatively multilayer films having a sealing layer made from or containing the polymer composition.

In some embodiments, the present disclosure provides a film made from or containing the polymer composition. In some embodiments, the film is a multilayer film having a sealing layer made from or containing the polymer composition.

In some embodiments, the multilayer films have at least the sealing layer made from or containing polymer composition. In some embodiment, the remaining layers are formed from other materials. In some embodiments, the other layers are made from or containing a polymer selected from the group consisting of a polypropylene homopolymers, propylene copolymers, polyethylene homopolymers, polyethylene copolymers, EVA, and other polymers.

In some embodiments, the combination and number of the layers of the multilayer structure varies. In some embodiments, the number of layers is from 3 to 11 layers or even more, alternatively 3 to 9 layers, alternatively 3 to 7 layers, alternatively 3 to 5 layers. In some embodiments, the combinations are selected from the group consisting of CB/A, CB/CB/A, and C/B/C/D/C/B/A, wherein at least one sealing layer A is made from or containing the polymer composition.

In some embodiments, the layers of the multilayer film are 3 or 5, wherein a sealing layer is made from or containing the polymer composition.

In some embodiments, the polymer composition is further made from or containing additives.

In some embodiments, the polymer composition consists essentially of components A) and B).

In some embodiments, component A) consists essentially of components A1) and A2).

As used herein, the term “consists essentially of” refers to the presence of specific further components, which components do not materially affect the essential characteristics of the compound or composition. In some embodiments, no further polymers are present in thy: polymer composition. In some embodiments, no further polyolefins are present in the polymer composition. The following examples are given to illustrate but not limit the present disclosure.

### EXAMPLES

Melt Flow Rate: measured according to ISO 1133-1(230° C., 2.16 Kg or 190° C., 2.16 Kg).

Tensile Modulus was measured according to ISO 527-2, and ISO 1873-2 on injection-molded sample.

Density was measured according to ISO 1183-1.

The density of samples was measured according to ISO 1183-1 (ISO 1183-1 method A “Methods for determining the density of non-cellular plastics—Part 1: Immersion method, liquid pyknorneter method and titration method”; Method A: Immersion method, for solid plastics (except for powders) in void-free form). Test specimens were taken from compression-molded plaques conditioned for 10 days before carrying out the density measure.

### Melting Temperature (ISO 11357-2013)

The melting temperature TmI was the melting temperature attributable to the crystalline form I of the copolymer. To determine the TmI, the copolymer sample was melted and then cooled down to 20° C. with a cooling rate of 10° C./min., kept for 10 days at room temperature, and then subjected to differential scanning calorimetry (DSC) analysis by cooling to −20° C. and then heating to 200° C. with a scanning speed corresponding to 10° C./min. In this heating run, the peak in the thermogram was taken as the melting temperature (Tml).

Ethylene Content in a 1-butene ethylene Copolymer

The content of comonomers was determined by infrared spectroscopy by collecting the IR spectrum of the sample vs. an air background with a Fourier Transform Infrared spectrometer (FTIR). The instrument data acquisition parameters were:
purge time: 30 seconds minimum
collect time: 3 minutes minimum
apodization: Happ-Genzel
resolution: 2 cm⁻¹.

Sample Preparation—Using a hydraulic press, a thick sheet was obtained by compression molding about 1 gram of sample between two aluminum foils. A small portion was cut from this sheet to mold a film. The film thickness was set to have a maximum absorbance of the CH₂ absorption band recorded at ˜720 cm⁻¹ of 1.3 a.u. (% Transmittance>5%). Molding conditions were a temperature of 180±10° C. (356° F.) with a pressure around 10 kg/cm² (142.2 PSI) for about one minute. The pressure was then released. The sample was removed from the press and cooled to room temperature. The spectrum of pressed film sample was recorded in absorbance vs. wavenumbers (cm⁻¹). The following measurements were used to calculate ethylene (C₂) and 1-butene (C₄) contents:
a) Area (Aₜ) of the combination absorption bands between 4482 and 3950 cm⁻¹ which was used for spectrometric normalization of film thickness.
b) Area (A_{C2}) of the absorption band due to methylenic sequences (CH₂ rocking vibration) in the range 660 to 790 cm⁻¹ after a proper digital subtraction of an isotactic polypropylene (IPP) and a C₂C₄ standard spectra.
c) The factor of subtraction (FCR_{C4}) between the spectrum of the polymer sample and the C₂C₄ standard spectrum. The standard spectrum was obtained by digital subtraction of a linear polyethylene from a C₂C₄ copolymer, thereby extracting the C₄ band (ethyl group at ˜771 cm−1).

The ratio A_{C2}/Aₜ was calibrated by analyzing standards ethylene-1-butene copolymer compositions, determined by NMR spectroscopy. To calculate the ethylene (C₂) and 1-butene (C₄) content, calibration curves were obtained by using standard samples of ethylene and 1-butene detected by ¹³C-NMR.

Calibration for ethylene—A calibration curve was obtained by plotting Ac₂/Aₜ versus ethylene molar percent (% C2m), and the coefficient a_{C2}, b_{C2}, and c_{C2} were calculated from a “linear regression”.

Calibration for 1-butene—A calibration curve was obtained by plotting FCR_{C4}/Aₜ versus butane molar percent (% C₄m) and the coefficients a_{C4}, b_{C4}, and C_{C4} were calculated from a “linear regression”.

The spectra of the samples were recorded. The (Aₜ), (A_{C2}), and (FCR_{C4}) of the samples were calculated.

The ethylene content (% molar fraction C2m) of the sample was calculated as follows:

$$\\ \% C 2 m = - {b}_{C 2} + \frac{\sqrt{{b}_{C 2}^{2} - 4 \cdot {a}_{C 2} \cdot ( {c}_{C 2} - \frac{{A}_{C 2}}{{A}_{t}} )}}{2 \cdot {a}_{C 2}}$$

The 1-butene content (% molar fraction C4m) of the sample was calculated as follows:

$$\\ \% C 4 m = - {b}_{C 4} + \frac{\sqrt{{b}_{C 4}^{2} - 4 \cdot {a}_{C 4} \cdot ( {c}_{C 4} - \frac{{FCR}_{C 4}}{{A}_{t}} )}}{2 \cdot {a}_{C 4}}$$

a_{C4}, b_{C4}, c_{C4}, a_{C2}, b_{C2}, c_{C2} are the coefficients of the two calibrations.
Changes from mol % to wt % were calculated by using molecular weights.

### Determination of the Comonomer Content in Component A

The comonomers content was determined by infrared spectroscopy by collecting the IR spectrum of the sample vs. an air background with a Fourier Transform Infrared spectrometer (FTIR); the instrument data acquisition parameters were:
purge time: 30 seconds minimum
collect time: 3 minutes minimum
apodization: Happ-Genzel
resolution: 2 cm⁻¹.

### Sample Preparation:

Using a hydraulic press, a thick sheet was obtained by pressing about 1 g of sample between two aluminum foils. A portion was cut from the sheet to mold a film. The film thickness ranged between 0.02 and0.05 cm (8-20 mils).

Pressing temperature was 180±10° C. (356° F.) and the pressure was about 10 kg/cm² (142.2 PSI).

After about 1 minute, the pressure was released. The sample was removed from the press and cooled to room temperature.

The spectrum of a pressed film of the polymer was recorded in absorbance vs. wavenumbers (cm⁻¹). The following measurements were used to calculate ethylene and 1-butene content:
Area (At) of the combination absorption bands between 4482 and 3950 cm⁻¹ was used for spectrometric normalization of film thickness.
AC2 was the area of the absorption band between 750-700 cm⁻¹ after two consecutive spectroscopic subtractions of an isotactic additive-free polypropylene spectrum and then of a standard spectrum of a 1-butene-propylene random copolymer in the range 800-690 cm⁻¹.
DC4 was the height of the absorption band at 769 cm⁻(maximum value), after two consecutive spectroscopic subtractions of an isotactic additive-free polypropylene spectrum and then of a standard spectrum of an ethylene-propylene random copolymer in the range 800-690 cm⁻¹.

To calculate the ethylene and 1-butene content, calibration straights lines for ethylene and 1-butene obtained by using standard samples of ethylene and 1-butene.

### Calibration of Ethylene:

Calibration straight line GC2 was obtained by plotting AC2/At versus ethylene molar percent (% C2m). The slope of GC2 was calculated from a linear regression.

Calibration of 1-butene:

Calibration straight line GC4 was obtained by plotting DC4/At versus 1-butene molar percent (% C4m). The slope of GC4 was calculated from a linear regression.

Spectrum of the sample was recorded and then (At), (AC2), and (DC4) of were calculated. The ethylene content (% molar fraction C2m) of the sample was calculated as follows:

$$\\ \% C 2 m = \frac{1}{{G}_{C 2}} \cdot \frac{{A}_{C 2}}{{A}_{t}}$$

The 1-butene content (% molar fraction C4m) of the sample was calculated as follows:

$$\\ \% C 4 m = \frac{1}{{G}_{C 4}} \cdot ( \frac{{A}_{C 4}}{{A}_{t}} - {I}_{C 4} )$$

The propylene content (molar fraction C3m) was calculated as follows:

C3m=100−% C4m−% C2m

The ethylene, 1-butene contents by weight were3 calculated as follows:

$$\\ \% C 2 wt = 100 \cdot \frac{28 \cdot C 2 m}{( 56 \cdot C 4 m + 42 \cdot C 3 m + 28 \cdot C 2 m )}$$

### Seal Initiation Temperature (SIT)

### Preparation of the Film Specimens

Some films with a thickness of 50 μm were prepared by extruding each test composition in a single screw Collin extruder (length/diameter ratio of screw 1:25) at a film drawing speed of 7 m/min and a melt temperature of 210-250° C.

Each resulting film was superimposed on a 1000 μm thick film of a propylene homopolymer having a xylene insoluble fraction at 25° C. of 97 wt % and an MFR L of 2 g/10 min.

The superimposed films were bonded to each other in a Carver press at 200° C. under a 9000 kg load, which was maintained for 5 minutes.

The resulting laminates were stretched longitudinally and transversally, that is, biaxially, by a factor of 6 with a Karo 4 Brueckener film stretcher at 160° C., thereby obtaining a 20 μm thick film (18 μm homopolymer+2 μm test).

### Determination of the SIT.

Film Strips, 6 cm wide and 35 cm length, were cut from the center of the BOPP film. The film was superimposed with a BOPP film made of PP homopolymer. The superimposed specimens were sealed along one of the 2 cm sides with a Brugger Feinmechanik Sealer, model HSG-ETK 745. Sealing time was 5 seconds at a pressure of 0.14 MPa (20 psi). The starting sealing temperature was from about 10° C. less than the melting temperature of the test composition. The sealed strip was cut into 6 specimens 15 mm wide long enough to be held in the tensile tester grips. The seal strength 12 FE7234-EP-P1 was tested at a load cell capacity 100 N, cross speed 100 mm/min, and grip distance 50 mm. The results were expressed as the average of maximum seal strength (N). The unsealed ends were attached to an Instron machine wherein the sample specimens were tested at a traction speed of 50 mm/min.

The test was repeated by changing the temperature as follows:

If seal strength<1.5 N, then decrease the temperature. Temperature variation was adjusted stepwise. If seal strength was close to target, steps of 1° C. were selected. If the strength was far from target, steps of 2° C. were selected.

As used herein, the term “target seal strength (SIT)” refers to the lowest temperature at which a seal strength higher or equal to 1.5 N is achieved.

### Determination of the Hot Tack

The hot tack measurement was determined after sealing by Brugger HSG Heat-Sealer (with Hot Tack kit). Samples obtained from BOPP film were cut at a minimum length of 200 mm and 15 mm width and tested at the following conditions:
The temperature was set from no sealing to 130° C. with an increase of 5° C. steps; at each temperature, set the weight to break the film in the neighborhood of the seal.

As used herein, a break of specimen occurred when 50% or more of the seal part was open after the impact.

### Solubility in Xylene 0/25° C.

2.5 g of copolymer and 250 cm³ of o-xylene were placed in a glass flask fitted with a condenser and a magnetic stirrer. The temperature was increased to the boiling point of the solvent over 30 min. The resulting, clear solution was left at reflux with stirring for a further 30 min. The closed flask was then placed in a bath of ice-water for 30 min and then in a bath of water thermostatically adjusted to 25° C. for 30 min. The resulting solid was then filtered off on filter paper at a high filtration rate. 100 cm³ of the liquid obtained from the filtration were poured into a pre-weighed aluminum container, which was placed on a hot-plate to evaporate off the liquid under a stream of nitrogen. The container was then placed in an oven at 80° C. and maintained under vacuum 45 until a constant weight was obtained. From the amount of filtrate, the amount of polymer soluble in xylene was calculated.

### Components A and B

Component A was Adsyl 5C 90F propylene polymer composition, which was commercially available from LyondellBasell. Component B was Koattro DP 8310M 1-butene ethylene copolymer, which was commercially available from LyondellBasell.

The features of component A are reported in Table 1.

TABLE 1

| | | Component A |
|---|---|---|
| MFR | g/10 min | 5.9 |
| C2 content in A | wt % | 3.2 |
| amount A1 | wt % | 35 |
| C2 content total | wt % | 3.2 |
| C4 content total | wt % | 6.6 |
| C2/C4 | | 0.48 |
| Xylene Soluble 0°/25° | wt % | 9.5 |
| Tm | | 132.4 |

C2 = ethylene

The features of component B are reported in Table 2.

TABLE 2

| | | Component B |
|---|---|---|
| MFR 190°C 2.16 kg | g/10 min | 3.5 |
| Flexural modulus | MPa | 120 |
| Tm | ° C. | 94 |
| Ethylene content | Wt% | 3.7 |

Various amount of component B were blended with component A. A two-layer BOPP film was produced for each blend. The two layers were made by the same component. The seal initiation temperature was measured. Table 3 reports the SIT for each sample.

TABLE 3

| ex | Comp B | SIT ° C. |
|---|---|---|
| Comp 1 | 0 | 102 |
| 2 | 15 wt % | 68 |
| 3 | 20 wt % | 68 |
| 4 | 25 wt % | 68 |

Comparative component B1 was Toppyl PB 8220M 1-butene ethylene copolymer, which was commercially available from LyondellBasell. The features of this polymer are reported in Table 4.

TABLE 4

| | | Component B1 |
|---|---|---|
| MFR 190°C 2.16 kg | g/10 min | 2.5 |
| Flexural modulus | MPa | 140 |
| Tm | 0 | 97 |
| Ethylene content | Wt % | 2.7 |

Various amount of component B1 were blended with component A. A two-layer BOPP film was produced for each blend. The two layers were made by the same component. The seal initiation temperature was measured. Table 5 reports the SIT for each sample.

TABLE 5

| ex | Comp B | SIT ° C. |
|---|---|---|
| Comp 5 | 0 | 102 |
| Comp 6 | 15 wt % | 74 |
| Comp 7 | 20 wt % | 73 |
| Comp 8 | 25 wt % | 69 |

### Hot Tack

The hot tack of the films of example 4 and example 8 were measured at various temperature. The results are reported in Table 6.

TABLE 6

| | Ex 4 | Comp ex 6 |
|---|---|---|
| Temp ° C. | Hot tack g | Hot tack g |
| 80 | 188 | 133 |
| 90 | 208 | 138 |
| 100 | 303 | 143 |
| 110 | 408 | 158 |
| 120 | 688 | 243 |

1. A polymer composition comprising:
A) from 70 wt % to 95 wt % of a propylene polymer composition comprising
A1) from 19 wt % to 50 wt % of a propylene ethylene copolymer having an ethylene derived units content ranging from 1.5 wt % to 6.0 wt %, based upon the total weight of the propylene ethylene copolymer; and
A2) from 50 wt % to 81 wt % of a propylene ethylene 1-butene terpolymer having an ethylene derived units content ranging from 1.5 wt % to 6.0 wt % and 1-butene derived units content ranging from 4.8 wt % to 12.4 wt %, based upon the total weight of the terpolymer;
wherein the propylene polymer composition has a xylene soluble fraction at 25° C. between 2 wt % and 15 wt %, based upon the total weight of the propylene polymer composition A), and
the sum of the amounts of A1) and A2) being 100 wt %; and
B) from 5.0 wt % to 30.0 wt % of a copolymer of 1-butene and ethylene containing from 3.0 wt % to 4.2 wt % of ethylene derived units, based upon the total weight of the 1-butene ethylene copolymer, and having:
a Melt Flow Rate: measured according to ISO 1133-1-(190° C., 2.16 Kg) ranging from 1.0 to 5.5 g/10 min;
a flexural modulus measured according to ISO 178 ranging from 80 MPa to 250 MPa; and
a melting temperature measured according to ISO 11357-2013 ranging from 83° C. and 108° C.,
wherein the sum of the amounts of A) and B) being 100 wt %.

2. The polymer composition according to claim wherein component A ranges from 72.0 wt % to 93.0 wt % and component B) ranges from 7.0 wt % to 28.0 wt %.

3. The polymer composition according to claim 1, wherein
Component A1 ranges from 25 wt % to 42 wt %; and
Component A2 ranges from 58 wt % to 75 wt %.

4. The polymer composition according to claim 1, wherein the 1-butene ethylene copolymer component B) contains from 3.2 wt % to 4.0 wt % of ethylene derived units, based upon the total weight of the 1-butene ethylene copolymer.

5. The polymer composition according to claim 1, wherein in component B), the Melt Flow Rate: measured according to ISO 1133-1-(190° C., 2.16 Kg) ranges from 2.1 to 4.8 g/10 min.

6. The polymer composition according to claim 1, wherein component A1) has ethylene derived units content ranging from 2.6 wt % to 5.2 wt %, based upon the total weight of the propylene ethylene copolymer.

7. The polymer composition according to claim 1, wherein component A2) has ethylene derived units content ranging from 1.9 wt % to 4.8 wt % and 1-butene derived units content ranging from 5.1 wt % to 10.5 wt %, based upon the total weight of the terpolymer.

8. The polymer composition according to claim 1, wherein component A) has a xylene soluble fraction at 25° C. between 5.0 wt % and 13.0 wt %, based upon the total weight of the propylene polymer composition A).

9. The polymer composition according to claim 1, wherein:
Component A1 ranges from 31 wt % to 38 wt %; and
Component A2 ranges from 62 wt % to 69 wt %.

10. The polymer composition according to claim 1, wherein the 1-butene ethylene copolymer component B) contains from 3.3 wt % to 3.9 wt % of ethylene derived units, based upon the total weight of the 1-butene ethylene copolymer.

11. The polymer composition according to claim 1, wherein component B) has a melting temperature measured according to ISO 11357-2013 ranging from 84° C. and 103° C., form I.

12. The polymer composition according to claim 1, wherein component B) has a flexural modulus measured according to ISO 178 ranging from 80 MPa to 210 MPa.

13. The polymer composition according to claim 1, wherein component B) has a Melt Flow Rate: measured according to ISO 1133-1 (190° C., 2.16 Kg) ranging from 2.4 to 4.1 g/10 min.

14. A film comprising the polymer composition of claim 1.

15. A multilayer film according to claim 14.
